(19) United States
(12) Patent Application Publication
(10) Pub. No.: US 2026/0135412 A1
(43) Pub. Date: May 14, 2026

(54) PHASE-BASED DEMODULATION IN WIRELESS POWER TRANSFER SYSTEMS

(71) Applicant: STMicroelectronics International N.V., Geneva (CH)

(72) Inventors: Giovanni Amedeo Cirillo, Torino (IT); Kevin Luciani, Milano (IT); Andrea Lorenzo Vitali, San Jose, CA (US); Roberta Priolo, Milano (IT)

(21) Appl. No.: 18/946,410

(22) Filed: Nov. 13, 2024

(51) Int. Cl. H02J 50/12; H02J 50/80; H04L 27/227

(52) U.S. Cl. CPC H02J 50/12; H02J 50/80; H04L 27/2273; H04L 2203/02

(57) ABSTRACT

According to an embodiment, a demodulator circuit for wireless power transfer systems addresses phase wrap-around issues in phase-shift keying (PSK) modulated signals. The demodulator converts received signals from Cartesian to polar coordinates. It performs phase correction to mitigate rapid fluctuations when the signal constellation approaches the negative real axis in the IQ plane. Phase correction techniques include applying a counter-controlled offset to rotate the constellation, removing the DC component using an exponential moving average filter, or employing a differential comb filter. The demodulator improves reliability in decoding backscatter communication from power receivers to transmitters, enhancing performance across various operating conditions and circuit configurations in wireless charging applications.

### TECHNICAL FIELD

The present disclosure generally relates to electronic devices and, in particular embodiments, to phase-based demodulation in wireless power transfer systems.

### BACKGROUND

Wireless power transfer systems allow power to be transferred from a power transmitter to a power receiver without a wired connection. One common technique for wireless power transfer is inductive coupling, which uses the mutual induction between two coils—one in the transmitter and one in the receiver—to transfer power.

In addition to power transfer, these systems often incorporate communication from the power receiver to the power transmitter to coordinate the charging process. The back-channel communication is typically implemented using a technique called backscatter modulation. In backscatter modulation, the power receiver modulates its load impedance, which causes detectable variations in the current or voltage of the transmitter coil through mutual induction.

The Qi standard is a widely adopted specification for wireless power systems. According to the Qi standard, backscatter modulation uses a binary amplitude shift keying (ASK) scheme, where two impedance states encode binary data. The modulation occurs at carrier frequencies typically between 100 and 250 kHz.

The power transmitter implements a demodulator to decode the backscattered signal. A common demodulator architecture uses in-phase and quadrature (IQ) mixing to downconvert the received signal to baseband. The baseband signal is typically passed through various filtering and processing stages before being sliced to recover the binary data.

While the Qi standard specifies ASK modulation, in practice, it may manifest as phase shift keying (PSK) for certain frequencies and circuit configurations. This occurs because the load impedance variation can result in phase changes rather than amplitude changes in the received signal. As a result, demodulators in wireless power systems are typically capable of handling both ASK and PSK modulation schemes.

The latest Qi 2.0 standard, released in 2024, explicitly acknowledges this issue in its Magnetic Power Profile (MPP) specification. The MPP specification notes the potential for spurious phase modulation and introduces requirements for demodulators to handle ASK and PSK signals.

### SUMMARY

Technical advantages are generally achieved by embodiments of this disclosure, which describe phase-based demodulation in wireless power transfer systems.

A first aspect relates to a system for wireless power transfer. The system comprising a receiving device configured to receive wireless power; and a transmitting device configured to transmit the wireless power to the receiving device, wherein the transmitting device comprises a demodulator circuit configured to receive a phase shift keying (PSK) modulated signal from the receiving device, convert the PSK modulated signal from Cartesian coordinates to polar coordinates, and perform phase correction on the converted signal to mitigate rapid phase fluctuations that occur when a signal constellation approaches a negative real axis in an in-phase and quadrature (IQ) plane.

A second aspect relates to a method for phase-based demodulation in a wireless power transfer system. The method comprising receiving a phase shift keying (PSK) modulated signal from a receiving device at a transmitting device; converting the PSK modulated signal from Cartesian coordinates to polar coordinates; and performing phase correction on the converted signal to mitigate rapid phase fluctuations occurring when a signal constellation approaches a negative real axis in an in-phase and quadrature (IQ) plane.

A third aspect relates to a demodulator circuit for a wireless power transfer system. The demodulator circuit comprising an in-phase and quadrature (IQ) mixer configured to downconvert a received phase shift keying (PSK) modulated signal; a pair of low-pass filters coupled to outputs of the IQ mixer; an in-phase and quadrature to magnitude and phase (IQ-to-MP) converter circuit coupled to outputs of the low-pass filters; and a phase correction circuit coupled to an output of the IQ-to-MP converter circuit, the phase correction circuit configured to mitigate rapid phase fluctuations occurring when a signal constellation approaches a negative real axis in an IQ plane.

Embodiments can be implemented in hardware, software, or any combination thereof.

### BRIEF DESCRIPTION OF THE DRAWINGS

For a more complete understanding of the present disclosure and the advantages thereof, reference is now made to the following descriptions taken in conjunction with the accompanying drawings, in which:

FIG. 1 is an embodiment wireless power system;

FIG. 2 is an embodiment receiving device;

FIG. 3 is an embodiment transmitting device;

FIG. 4 is a schematic of an embodiment sensing circuit;

FIG. 5 is a block diagram of an embodiment demodulator circuit;

FIG. 6 illustrates a challenge in phase-based demodulation for wireless power systems;

FIG. 7 illustrates a challenge of phase discontinuities in wireless power transfer systems utilizing phase-based demodulation;

FIG. 8 illustrates the effect of applying an example phase rotation to the IQ signal from FIG. 7;

FIGS. 9 and 10 are block diagrams of embodiment demodulator circuits;

FIG. 11 is a schematic of an embodiment phase correction circuit;

FIG. 12 is a simplified schematic of an embodiment clamping circuit;

FIG. 13 is a flowchart of an embodiment method;

FIG. 14 is a schematic of an embodiment phase correction circuit;

FIG. 15 is a schematic of an embodiment input clamping circuit;

FIG. 16 is a schematic of an embodiment conditioning circuit;

FIG. 17 is a flow chart of an embodiment method;

FIG. 18 is a schematic of an embodiment phase correction circuit; and

FIG. 19 is a flow chart of an embodiment method.

### DETAILED DESCRIPTION OF ILLUSTRATIVE EMBODIMENTS

This disclosure provides many applicable inventive concepts that can be embodied in a wide variety of specific contexts. The particular embodiments are merely illustrative of specific configurations and do not limit the scope of the claimed embodiments. Features from different embodiments may be combined to form further embodiments unless noted otherwise. Various embodiments are illustrated in the accompanying drawing figures, where identical components and elements are identified by the same reference number, and repetitive descriptions are omitted for brevity.

Variations or modifications described in one of the embodiments may also apply to others. Further, various changes, substitutions, and alterations can be made herein without departing from the spirit and scope of this disclosure as defined by the appended claims.

While the inventive aspects are described primarily in the context of wireless power transfer systems using inductive coupling, it should also be appreciated that these inventive aspects may also apply to other wireless power transfer technologies. In particular, aspects of this disclosure may similarly apply to capacitive coupling, magnetic resonance, and radio frequency (RF) wireless power transfer systems. The demodulation techniques described could be adapted for use in these other wireless power transfer modalities where similar backscatter communication challenges may be encountered.

Aspects of the disclosure relate to a demodulator for wireless power transfer systems. In embodiments, the demodulator can handle amplitude shift keying (ASK) and phase shift keying (PSK) modulation schemes, which can useful in power transmitters decoding backscatter modulation from power receivers.

The demodulator may employ in-phase and quadrature (IQ) mixing to downconvert the received signal to baseband. After low-pass filtering, the baseband signal can be converted from Cartesian (IQ) coordinates to polar (magnitude-phase) coordinates. A phase correction module can be applied to address potential phase wrap-around issues that can occur when the signal constellation is near the negative real axis in the IQ plane.

In embodiments, three phase-correction strategies are described. One approach involves applying a counter-controlled offset to rotate the signal constellation. Another uses automatic phase correction based on a DC-extracting filter. A third strategy utilizes a differential comb filter for automatic phase correction.

The phase correction techniques may help mitigate unwanted phase fluctuations that can interfere with symbol decoding. The demodulator can provide performance across various operating conditions and circuit configurations by addressing ASK and PSK modulations and phase wrap-around issues.

In embodiments, the demodulator architecture may also include DC removal, which can be integrated with the phase correction. A slicer can make binary decisions on the processed signal following phase correction and DC removal. Symbol decoding can then be performed to recover the transmitted information.

Embodiments of the disclosed demodulator may be beneficial in wireless power transfer systems that are compliant with standards that recognize the potential for spurious phase modulation in addition to intended amplitude modulation. The demodulator's adaptive nature allows it to handle different modulation types, potentially enhancing the reliability of the backscatter communication link. These and additional details are further detailed below.

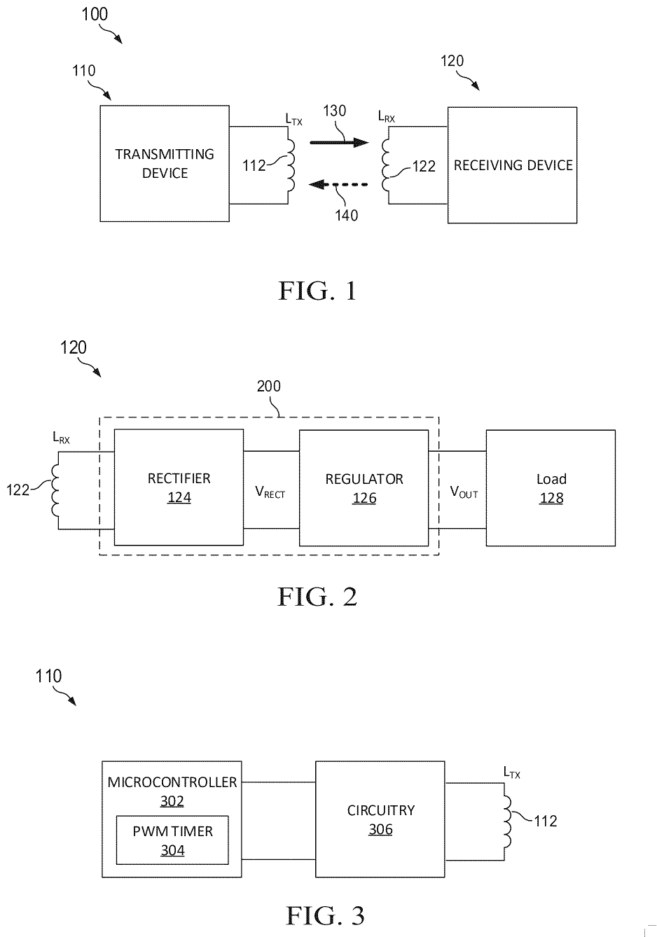

FIG. 1 illustrates an embodiment wireless power system 100, which may also be called a wireless charging system. The system includes a transmitting device 110 and a receiving device 120, which may (or may not) be arranged as shown. The transmitting device 110 generates and transmits wireless energy 130 to the receiving device 120.

The transmitting device 110 may be a base station, such as a charging pad, which provides inductive power to the receiving device 120. The receiving device 120 can be, for example, a mobile device, a tablet, a cellular phone, a wearable communications device (e.g., a smartwatch), a digital pen, a wireless headphone, a toothbrush, a sensor, internet of things (IoT) device, or the like. The receiving device 120 is the consumer of inductive power.

The transmitting device 110 includes a transmitter coil 112 (L_{TX}). The receiving device 120 includes receiver coil 122 (L_{RX}). Each coil, or winding, can be a loop or magnetic antenna. The coils may have a physical core (e.g., ferrite core) or an air core. The coils may be implemented as an antenna strip or using a Litz wire. The resonant frequency of each coil is based on the shape and size of the looping wire or coil. In some embodiments, additional capacitance and inductance may be added to each coil to create a resonant structure at the desired resonant operating frequency.

In embodiments, the wireless energy 130 is transmitted from the transmitting device 110 to the receiving device 120 using resonant inductive coupling between the transmitter coil 112 and the receiver coil 122. The receiving device 120 may use the power to charge rechargeable batteries or power the components within it directly.

The wireless power system 100 also includes a backscatter communication link 140, represented by the dashed arrow, from the receiving device 120 to the transmitting device 110. The backscatter communication link 140 allows the receiving device 120 to communicate information back to the transmitting device 110, which can be used for power control, device identification, or other purposes.

FIG. 2 illustrates an embodiment receiving device 120. The receiving device 120 includes the receiver coils 122, a power charging circuit 200, and a load 128. The power charging circuit 200 includes a rectifier 124 and a regulator 126. The receiving device 120 may include additional components not depicted in FIG. 2, such as long-term storage (e.g., non-volatile memory, etc.), a non-transitory computer-readable medium, one or more antenna elements, drivers, demodulators, modulators, filter circuits, and impedance matching circuits.

The rectifier 124 converts the alternating current (AC) voltage at the receiver coils 122 to a direct current (DC) voltage. It may be any type of rectifier, such as a low-impedance synchronous rectifier having full-wave or half-wave rectification or an active rectifier. In embodiments, the rectifier 124 may be a bridge rectifier; however, other types of rectifiers are also contemplated.

The regulator 126 receives a voltage (V_{RECT}) from the rectifier 124 and then regulates that voltage to maintain a constant output voltage (V_{OUT}) at load 128. The regulator 126 may be any type of voltage regulator, such as a linear regulator (e.g., low drop-out (LDO) linear regulator). In some embodiments, the rectifier 124 and the regulator 126 may be part of a switched-mode power supply (SMPS) circuit.

As shown, load 128 is the primary benefactor of the transferred wireless energy 130. The load 128 may be a charge storage device, such as a battery. For instance, load 128 may be a cellular phone battery or a smartwatch. For example, the transmitting device 110 may be a charging pad and a smartwatch may be placed on the charging pad. The charging pad transfers wireless power to the smartwatch's battery without connecting cables between the two devices.

Several interface standards have been developed to standardize wireless power transfer and related functions. One such interface standard is Qi, which the Wireless Power Consortium (WPC) promotes. Qi and similar standardized protocols may be used to define the communication interface for controlling the power transfer in the wireless power system 100. For instance, the receiving device 120 may request a change (e.g., an increase, a decrease, a pause, etc.) related to the transferred wireless energy 130 from the transmitting device 110.

The mechanism of inductive power transfer can also be utilized for communication between the transmitting device 110 and the receiving device 120. For instance, the receiving device 120 can inform the transmitting device 110 when the charging process is complete. This communication can be facilitated through a technique known as backscatter modulation, as specified in the Qi Standard for inductive wireless power transfer.

In practice, the receiving device 120 can alter its load impedance by, for example, changing the impedance of the load 128. The change in the impedance results in observable variations in the amplitude of the current or voltage in the transmitter coil 112, allowing information to be transmitted from the receiving device 120 to the transmitting device 110 and consequently the implementation of the backscatter communication link 140.

FIG. 3 illustrates an embodiment transmitting device 110. The transmitting device 110 includes a microcontroller 302, additional circuitry 306, and the transmitter coil 112, which may (or may not) be arranged as shown. Transmitting device 110 may include memory for storage. In embodiments, microcontroller 302 includes embedded memory. In embodiments, the PWM timer circuit 304 is embedded within the microcontroller 302.

Generally, a digital modulation scheme represents digital data using a finite number of distinct signals. ASK modulation refers to a modulation scheme in which digital data is represented as variations in the amplitude of a carrier wave.

In ASK-based communication, the transmitting device 110 generates a carrier signal. The carrier signal is typically a sinusoidal wave produced by filtering a PWM-generated square wave. The digital information to be transmitted modulates the amplitude of the carrier signal.

In embodiments, the PWM timer circuit 304 embedded within the microcontroller 302 generates a PWM square wave based on programmed parameters. Microcontroller 302 can precisely control the square wave's frequency, duty cycle, and timing.

In embodiments, PWM timer circuit 304 employs frequency dithering by slightly varying the signal frequency according to a predetermined pattern stored in a dithering table. The modulated and dithered signal is sent to the transmitter coil, generating an electromagnetic field for power transfer and data communication. The approach allows for simultaneous power transfer and data transmission, with the data essentially riding on the power transfer signal.

After PWM timer circuit 304 generates the digital square wave, it is passed through additional circuitry 306, such as a power inverter and a filter, to create a sinusoidal wave used in the inductive power transfer process. The receiving device 120 rectifies the induced signal at the receiver coil 122, which charges the receiving device 120. In embodiments, the resonant filtering is performed by a capacitor and the transmitter coil 112.

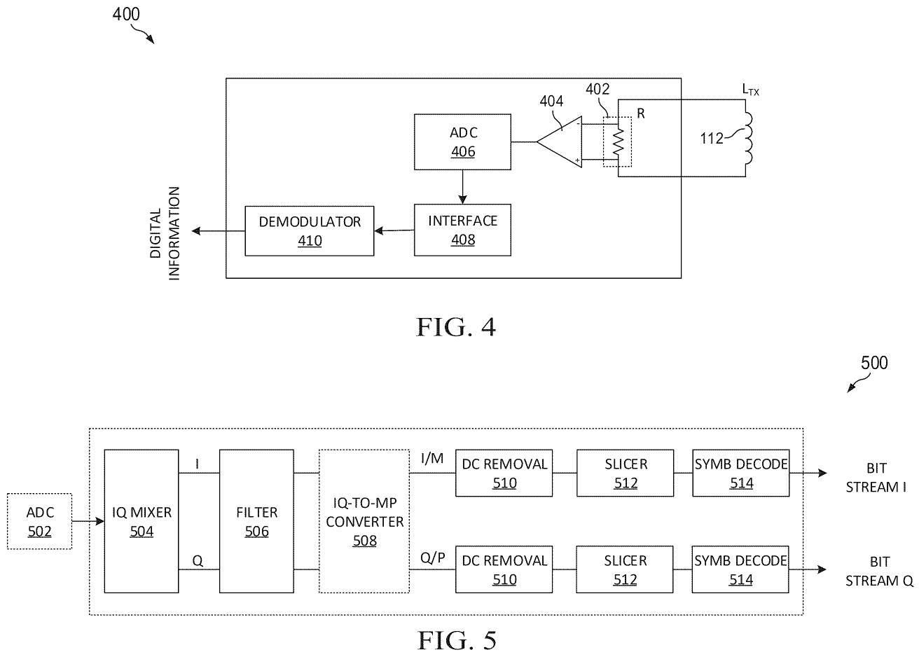

FIG. 4 illustrates a schematic of an embodiment sensing circuit 400, which may be in transmitting device 110 for backscatter modulation detection. Sensing circuit 400 is coupled to the terminals of the transmitter coil 112. Sensing circuit 400 includes a sense resistor (R) 402, an amplifier 404, an analog-to-digital converter (ADC) 406, an interface 408, and a demodulator circuit 410, which may (or may not) be arranged as shown. Sensing circuit 400 may include additional components not shown.

When the receiving device 120 modulates its load 128 (for example, by changing its impedance), this causes detectable changes in the current or voltage of the transmitter coil 112. The changes are typically small amplitude variations in the current or voltage at the transmitter coil 112. Sensing circuit 400 continuously monitors the characteristics of the transmitter coil 112, such as current or voltage.

The sense resistor 402 detects the variations through the transmitter coil 112. The voltage across the sense resistor 402 is proportional to the coil current. The amplifier 404 amplifies the voltage across the sense resistor 402 and feeds it into the ADC 406.

ADC 406 converts the amplified analog voltage across the sense resistor 402 to a digital signal. In embodiments, ADC 406 is coupled to the demodulator circuit 410 through the interface 408. In embodiments, interface 408 involves a serial data interface and a pre-conditioning digital signal processing unit, responsible for either removing residual DC components or band-pass filtering in the neighborhood of the ASK carrier frequency or windowing the incoming signal. In embodiments, interface 408 is a four-lane serial peripheral interface (SPI4L), followed by offset removal and a resonant-like digital filter.

The digital signal from the ADC 406 is demodulated by the demodulator circuit 410. Demodulator circuit 410 analyzes the amplitude variations in the digital signal to extract the digital information sent by the receiving device 120.

The backscatter modulation used in Qi-compliant wireless power transfer systems typically employs Amplitude Shift Keying (ASK). However, in certain frequency ranges, typically between 100 and 250 kHz, the modulation may manifest as Phase Shift Keying (PSK) instead of ASK.

The Magnetic Power Profile (MPP) specification of the Qi 2.0 standard, released in 2024, acknowledges the issue of spurious phase modulation and introduces the need for demodulators capable of handling ASK and PSK modulation schemes. By accommodating ASK and PSK modulation, demodulators in the transmitting device 110 can enhance reliability across the range of carrier frequencies used. The approach aligns with evolving standards recognizing the potential for unintended phase modulation and the specified amplitude modulation.

To address these challenges, embodiments of the disclosure incorporate a circuit that translates information from Cartesian (InPhase-Quadrature) coordinates to polar (Magnitude-Phase) coordinates in the demodulation chain. The translation may facilitate easier handling of PSK demodulation when it occurs.

FIG. 5 illustrates a block diagram of an embodiment demodulator circuit 500, which can be implemented as the demodulator circuit 410 in FIG. 4. The demodulator circuit 500 includes an analog-to-digital converter (ADC) 502, an IQ mixer 504, a filter 506, an optional IQ-to-MP converter circuit 508, DC removal high-pass filters (HPF) 510, slicers 512, and symbol decoding circuits 514, which may (or may not) be arranged as shown. Demodulator circuit 500 may include additional components not shown.

The ADC 502 can be similar to the ADC 406 shown in FIG. 4. It acquires modulated samples from the primary coil of the transmitting device 110, which represent the backscatter modulated signal from the receiving device 120.

The IQ mixer 504 is coupled to the output of the ADC 502. It shifts the transmitted signal spectrum into the baseband domain, centering it around DC (0 Hz). The process is commonly referred to as downconversion.

In operation, the IQ mixer 504 multiplies the incoming digitized signal from the ADC 502 with local oscillator (LO) signals. The LO signals are typically sine waves at the carrier frequency of the received signal but can differ in phase by 90 degrees. One LO signal is considered the “In-phase” (I) reference, while the other is the “Quadrature” (Q) reference.

The input signal is multiplied with the I reference to produce the I component of the baseband signal. Similarly, multiplication with the Q reference yields the Q component. The process effectively separates the received signal into two orthogonal components, preserving all the information contained in the original signal.

The resulting I and Q signals represent the real and imaginary parts of the complex baseband signal, respectively. The complex representation allows for easier processing and analysis of amplitude and phase information, which can be particularly useful for handling ASK and PSK modulations that may be present in the wireless power system 100.

By shifting the signal to baseband, the IQ mixer 504 can reduce the subsequent processing requirements. The baseband signal has a much lower frequency content than the original RF signal, allowing for more efficient filtering and sampling in the following stages of the demodulator.

The filter 506 is coupled to the outputs of the IQ mixer 504. They are typically configured to act as an image rejection filter and apply decimation to the downconverted signal.

As an image rejection filter, filter 506 removes high-frequency artifacts generated by the IQ mixer 504 during the downconversion process. The artifacts can include mixer products, harmonics, and other unwanted spectral components outside the desired baseband frequency range. By attenuating the high-frequency components, the filter 506 helps to isolate the desired baseband signal and improve the overall signal-to-noise ratio. In embodiments, the filter 506 executes low-pass filtering and can additionally perform notch filtering.

In addition to filtering, the filter 506 may incorporate decimation. Decimation involves reducing the signal's sampling rate, which can be done safely after low-pass filtering because the bandwidth requirements are decreased after downconversion. The decimation process typically involves discarding some samples or averaging groups of samples to produce a single output sample.

The decimation factor can be chosen based on the ratio between the ADC sampling rate and the desired output rate, which is often related to the symbol rate of the received signal. By reducing the sample rate, decimation helps to lower the computational requirements for subsequent processing stages and can improve the effective resolution of the signal.

Various digital filter structures can be used to implement the filter 506 with decimation. Common approaches include finite impulse response (FIR) filters, infinite impulse response (IIR) filters, or cascaded integrator-comb (CIC) filters. The choice of filter structure depends on factors such as the required stopband attenuation, passband ripple, phase linearity, and computational efficiency.

In wireless power transfer systems, where ASK and PSK modulations may be present, the filter 506 helps condition the signal for subsequent processing stages, ensuring that the baseband signal is clean and appropriately sampled for accurate demodulation.

The optional IQ-to-MP converter circuit 508 is coupled to the outputs of the filter 506 and converts the signal representation from Cartesian (IQ) coordinates to polar (Magnitude-Phase or MP) coordinates. The conversion can be useful for handling PSK modulation, which may occur in certain frequency ranges of wireless power transfer systems.

In operation, the IQ-to-MP converter circuit 508 takes the signal's I and Q components and transforms them into magnitude (M) and phase (P) components. The magnitude represents the signal's amplitude, while the phase represents its angular position in the complex plane.

The conversion from IQ to MP coordinates typically involves a magnitude calculation (i.e., M=\sqrt{I²+Q²}) and a phase calculation (i.e., P=arctan2(Q, I). The magnitude calculation uses the Pythagorean theorem to determine the signal's amplitude (M). The phase calculation employs the two-argument arctangent function (atan2) to compute the phase angle (P), which provides a full 360-degree range of angles.

Various methods can be used to implement the calculations in hardware. For the magnitude and phase calculations, the COordinate Rotation DIgital Computer (CORDIC) algorithm in vectoring mode can be employed. This approach allows for efficient computation of the operations required for computing the magnitude and phase.

The CORDIC algorithm in vectoring mode can compute the arctangent for the phase calculation. Alternatively, look-up tables (LUTs) or polynomial approximations may be employed for faster, albeit less accurate, phase computations.

The IQ-to-MP converter circuit 508 may include additional logic to handle phase unwrapping. Phase unwrapping addresses the discontinuity when the phase angle crosses the ±π boundary, ensuring a continuous phase representation.

In wireless power transfer systems, the IQ-to-MP conversion can be beneficial when dealing with PSK modulation. PSK modulation encodes information in the phase of the signal, making the phase component directly relevant for demodulation. By explicitly calculating the phase, the demodulator circuit 500 can more easily detect and interpret phase shifts in the received signal.

Moreover, having magnitude and phase information available can allow the demodulator circuit 500 to adapt to varying modulation schemes. For example, it can handle ASK modulation by focusing on magnitude changes, PSK modulation by tracking phase changes, or even combined modulation schemes by monitoring both components.

The conversion stage's optional nature allows the demodulator circuit 500 to be flexible, adapting to different system requirements and modulation schemes that may be encountered in wireless power transfer applications.

The DC removal high-pass filters (HPF) 510 are coupled to either the outputs of the filter 506 or the optional IQ-to-MP converter circuit 508, depending on the specific configuration of the demodulator circuit 500. The DC removal high-pass filters (HPF) 510 are configured to remove the DC component that typically emerges during the downconversion process.

During downconversion, a DC offset can be introduced into the signal due to factors such as local oscillator (LO) leakage, mixer imbalance, or even a strong interferer. If left unaddressed, the DC offset can saturate subsequent demodulator stages and potentially lead to incorrect symbol decisions.

The DC removal high-pass filters (HPF) 510 are configured to attenuate very low-frequency components, effectively removing the DC offset while allowing higher-frequency components (which contain the desired signal information) to pass through. The cutoff frequency of the DC removal high-pass filters (HPF) 510 is typically set well below the lowest frequency of interest in the modulated signal but high enough to remove the DC component effectively.

In digital implementations, the DC removal high-pass filters (HPF) 510 can be realized using various filter structures. One common approach is to use a first-order Infinite Impulse Response (IIR) filter. Another approach is to use a Finite Impulse Response (FIR) filter designed with a high-pass response. FIR filters offer advantages regarding linear phase response and stability but may require more computational resources than IIR filters.

For systems dealing with I and Q channels (or M and P in polar coordinates), separate high-pass filters are typically employed for each channel to ensure proper DC removal across all signal components.

The DC removal high-pass filters (HPF) 510 may incorporate adaptive techniques for varying DC offsets. The adaptive filters can adjust their parameters in real time based on the input signal characteristics, providing more robust DC removal across different operating conditions.

In wireless power transfer systems, effective DC removal can be important for maintaining the integrity of the modulated signal, whether it is ASK or PSK modulation. By removing the DC component, these filters help center the signal around zero, facilitating more accurate symbol detection in subsequent demodulator stages.

The slicers 512 are coupled to the outputs of the DC removal high-pass filters (HPF) 510. In wireless power transfer systems, slicers 512 help clean up the received signal, which may have been affected by noise and distortions during transmission.

Due to the previous DC removal stage, each slicer 512 accepts a typically symmetric signal around zero. The slicers 512 perform a binary decision based on a threshold parameter. The threshold determines the decision boundary between the two output states, affecting how the incoming signal is interpreted as binary data.

The process compresses information from multiple bits to a single bit, creating a two-level output. The slicers 512 are substantially hysteresis comparators. In operation, the slicer 512 compares the incoming signal level to a couple of opposite thresholds. If the signal level is above the positive threshold, the slicer outputs one binary state (e.g., a logical ‘1’). If the signal level is below the negative threshold, it outputs the other binary state (e.g., a logical ‘0’).

Slicers 512 prepare the signal for subsequent symbol decoding by compressing the multi-bit input into a single-bit output. This compression simplifies the data stream while preserving the essential information encoded in the signal's amplitude variations.

The symbol decoding circuits 514 are coupled to the outputs of the slicers 512 and interpret the binary stream to extract meaningful data according to the communication protocol used in the wireless power transfer system. In the context of wireless power transfer systems that are compliant with the Qi standard, the symbol decoding circuits 514 are designed to handle bi-phase mark coding. This coding scheme is synchronized with a clock signal with a frequency of 2 kHz±4%, which also corresponds to the bit rate of the communication.

The bi-phase mark coding used in Qi-compliant systems has specific characteristics that the symbol decoding circuits 514 recognize. There is a systematic edge at the beginning of each clock period. The absence of an intermediate transition within the bit period represents a ‘0’ bit. A ‘1’ bit is represented by a transition at the mid-point of the bit period.

To decode the information, the symbol decoding circuits 514 may employ edge detection mechanisms to identify the transitions in the binary stream from the slicers 512. The symbol decoding circuit 514 can determine whether each bit period contains a ‘0’ or a ‘1’ by analyzing the presence or absence of these mid-bit transitions.

In embodiments, the symbol decoding circuit 514 handles the message structure defined by the Qi standard. Typically, a message begins with a preamble consisting of a sequence of consecutive ‘1’ bits. The number of preamble bits may vary depending on the specific bit rate. After the preamble, the symbol decoding circuits 514 identifies a start bit (always ‘0’), one data byte (8 bits of actual information), a parity bit (set to ‘1’ if the data byte contains an even number of ‘1’ bits), and a stop bit (always ‘1’).

To accomplish this, the symbol decoding circuit 514 may incorporate state machines or sequence detectors to track the progression through the message components. This allows the symbol decoding circuit 514 to properly frame the incoming data and extract the relevant information bits. The symbol decoding circuit 514 may also include error detection mechanisms. For instance, they can verify the parity bit to ensure the integrity of the received data byte. If a parity error is detected, the circuits may flag the data as potentially corrupted.

In systems where ASK and PSK modulations are possible, symbol decoding circuit 514 may need to adapt its decoding strategy based on the detected modulation type. This could involve switching between different decoding algorithms or combining information from the signal's amplitude and phase components.

The output of the symbol decoding circuit 514 is typically a stream of decoded data bytes, representing the information transmitted from the receiving device 120 to the transmitting device 110. The data may include information about power requirements, device identification, or other control signals relevant to the wireless power transfer process.

The demodulator circuit 500 processes the received signal through these stages to extract the digital information sent by the receiving device 120. The arrangement allows for flexible handling of ASK and potential PSK modulations, addressing the challenges posed by spurious phase modulation in certain frequency ranges of wireless power transfer systems.

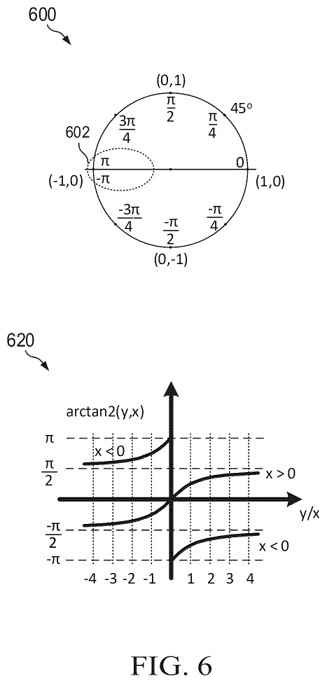

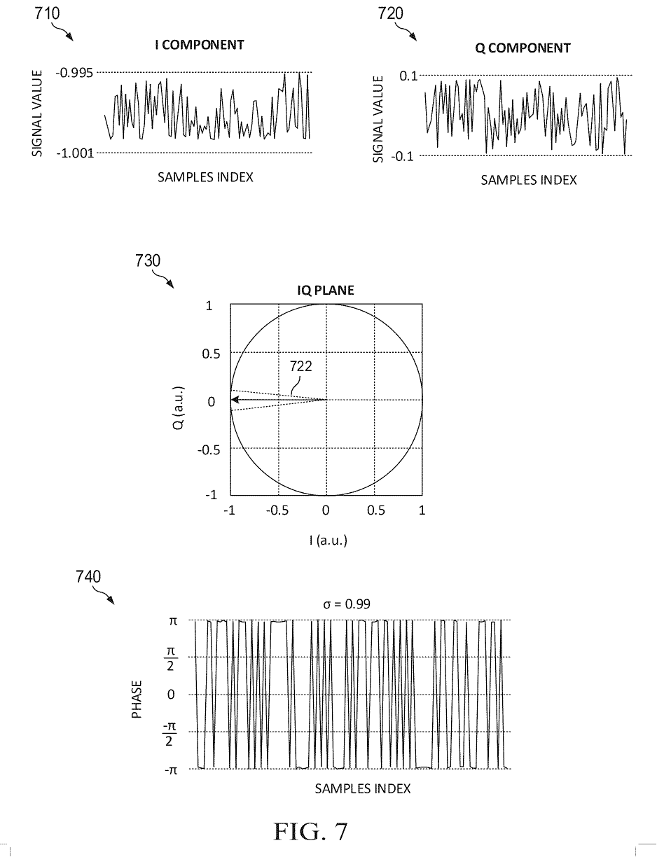

FIG. 6 illustrates a challenge in phase-based demodulation for wireless power systems. The figure depicts two aspects: the unit circle 600 representation of phase with the phase angles marked and the two-argument arctangent (atan2) function behavior 620.

The dashed ellipse 602 illustrated in unit circle 600 highlights the region near (−1,0), representing a problematic zone where phase discontinuities can occur during demodulation. The two-argument arctangent function behavior 620 illustrates the mapping of the y/x coordinate ratios to angles in the [−π, +π] range. A discontinuity occurs along the negative x-axis, where the phase jumps from −π to +π and vice versa. The discontinuity can cause challenges in accurately determining phase changes when the signal constellation approaches this region.

The two-argument arctangent function, denoted as φ=atan2(y, x), defines the phase angle in the complex plane. The two-argument arctangent function is a variation of the standard arctangent function that takes two arguments instead of one. Unlike the standard arctangent function, which returns values in the range [−π/2, π/2], the two-argument arctangent function returns values over the full range of [−π, π].

The expanded range allows the two-argument arctangent function to determine the correct angle quadrant based on the signs of x and y inputs. As a result, the two-argument arctangent function can distinguish between diametrically opposite directions, such as (1,1) and (−1,−1), which would yield the same result with a standard arctangent. This property makes the two-argument arctangent function particularly useful in applications requiring precise angle measurements, such as coordinate transformations, navigation systems, and phase-shift keying (PSK) demodulation in wireless power transfer systems, where the full 360-degree phase range is utilized.

Accordingly, the two-argument arctangent function can extract phase information from the received signal in demodulation applications. PSK demodulators can use the two-argument arctangent function to determine signal phase across the four quadrants of the complex plane. The relationship can be expressed as φ=atan2(Q, I), where I and Q are the in-phase and quadrature components, respectively, after low-pass filtering, and φ represents the angle measured in radians between the positive x-axis and the ray from the origin to the point (x, y) in the Cartesian plane. Equivalently, φ=atan2(Q, I) can be understood as the argument of the complex number I+iQ.

The two-argument arctangent operation allows the demodulator circuit 500 to convert the Cartesian representation of the complex number (I+iQ) into its polar form, isolating the phase information. By applying the two-argument arctangent function to the filtered IQ components, the demodulator circuit 500 can track phase changes in the received signal, which is advantageous in phase-modulated data in systems that may exhibit PSK-like characteristics.

Various methods can be employed to implement the two-argument arctangent function. For example, a hardware implementation can use a vectoring-mode CORDIC, returning the angle in fixed-point representation. The CORDIC algorithm principle starts at a point (1, y) and rotates the vector until the y-component approaches zero. The accumulated rotation angle corresponds to the arctangent of the original y value. This approach can efficiently compute arctangent values in digital hardware, making it suitable for demodulator circuits 500.

When the I/Q phasor nears the negative x-axis (dashed ellipse 602), small Q component fluctuations can cause large, rapid phase changes due to the two-argument arctangent function discontinuity, also known as phase wrap-around. The abrupt variations can lead to symbol detection and decoding errors, potentially affecting the reliability of the communication link between the receiving device 120 and the transmitting device 110.

Advantageously, embodiments of the disclosure address the phase wrap-around issue to ensure robust demodulation, particularly in systems that encounter PSK-like modulation characteristics. Demodulation techniques can be developed to handle these phase discontinuities while maintaining accurate symbol detection across various operating conditions and circuit configurations.

FIG. 7 illustrates the challenge of phase discontinuities in wireless power transfer systems utilizing phase-based demodulation. The figure comprises four panels demonstrating an example In-phase (I) component 710, an example Quadrature (Q) component 720, their representation in the IQ plane 730, and the resulting phase variations 740.

The I component 710 of the signal over a series of sample indices illustrates that it fluctuates around a value close to-1, indicating that the signal constellation is near the negative x-axis of the IQ plane 730. Similarly, the Q component 720 of the signal over a series of sample indices illustrates that it oscillates around zero with small positive and negative values.

The IQ plane 730 is depicted with a unit circle. A cluster 722, near the point (−1,0), represents the distribution of the IQ samples. The proximity of cluster 722 to the negative x-axis illustrates the region where the two-argument arctangent function exhibits a discontinuity.

The resulting phase variations 740 illustrate the consequence of the signal constellation position. They show the phase computed by the two-argument arctangent function for each sample. The phase values exhibit extreme fluctuations between −π and +π, as indicated by the lines spanning the full range of the y-axis and the high standard deviation σ (i.e., σ=0.99). Rapid phase changes occur despite small variations in the Q component due to the two-argument arctangent function discontinuity at the negative x-axis.

In this example, the I component 710 and the Q component 720 of the signal are in a neighborhood of the (−1,0) point in the plane. An analogous distribution of IQ points in a neighborhood of another point on the unit circle and away from the discontinuity region would provide variations of the two-argument arctangent function that are definitively smaller, resulting in a lower σ value.

The unwanted phase commutations can impact bit recognition in the demodulation process. The rapid switching between −π and +π may be misinterpreted as actual phase shifts in the modulated signal, potentially leading to bit errors. Consequently, addressing the phase variations becomes advantageous for maintaining reliable communication in wireless power transfer systems that may encounter phase-shift keying (PSK) like modulation characteristics.

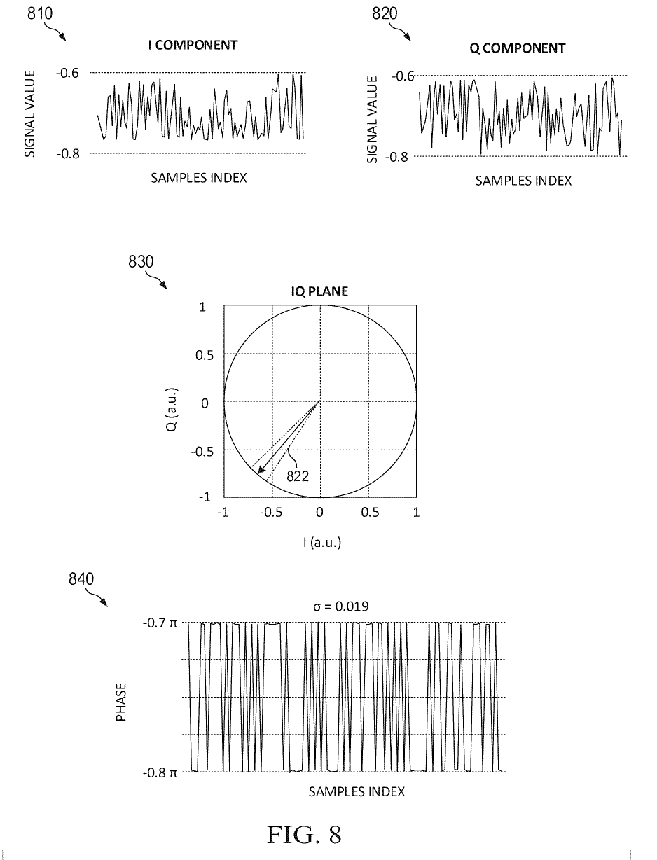

FIG. 8 illustrates the effect of applying an example phase rotation to the IQ signal from FIG. 7. The figure comprises four panels demonstrating an example In-phase (I) component 810, an example Quadrature (Q) component 820, their representation in the IQ plane 830, and the resulting phase variations 840.

The I component 810 of the rotated signal over a series of sample indices illustrates that it fluctuates around a value of approximately −0.7, indicating that the signal constellation has been moved away from the negative x-axis of the IQ plane 830. Similarly, the Q component 820 of the signal over a series of sample indices illustrates that it oscillates around −0.7.

The IQ plane 830 is depicted with a unit circle. A cluster 822 is now in the third quadrant, away from the negative x-axis. The new position represents the distribution of the IQ samples after a rotation of π/4 radians (45 degrees) has been applied. The rotation moves the signal constellation away from the critical region near the negative x-axis where the two-argument arctangent function exhibits the discontinuity.

The resulting phase variations 840 reveal the consequence of this rotation. It shows the phase computed by the two-argument arctangent function for each sample of the rotated signal. In contrast to the extreme fluctuations seen in FIG. 7, the phase values exhibit much smaller variations. These phase values are confined to a narrow range of around −0.75π radians.

The phase standard deviation (σ) is 0.019, significantly lower than the 0.99 in FIG. 7. This quantifies the substantial reduction in phase fluctuations achieved by the rotation.

Accordingly, unwanted fluctuations can be mitigated by implementing an IQ-plane frame change that moves the phasor away from the region near the negative x-axis. Rotating the IQ samples by, for example, π/4 radians allows for a significant reduction in phase fluctuations.

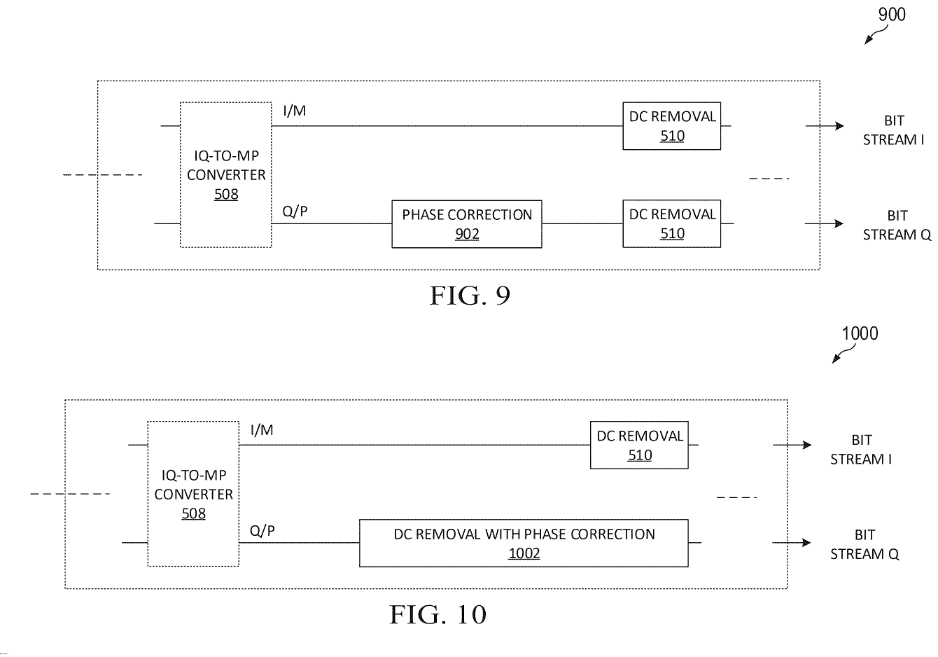

FIGS. 9 and 10 illustrate block diagram of an embodiment demodulator circuit 900 and 1000, which can be implemented as the demodulator circuit 410 in FIG. 4. The demodulator circuit 900 includes an IQ-to-MP converter circuit 508, a phase correction circuit 902, and a DC removal high-pass filter (HPF) 510, which may (or may not) be arranged as shown. This configuration allows for more flexibility and easier isolation of the phase correction functionality, which can be beneficial for testing and optimization purposes.

In the demodulator circuit 1000, the functionality of the DC removal high-pass filters (HPF) 510 is integrated with the phase correction circuit 902 and implemented with the DC removal with phase correction circuit 1002. The integrated approach can reduce overall circuit complexity and improve efficiency in some implementations.

The choice between the demodulator circuit 900 or demodulator circuit 1000 depends on various factors such as the specific system requirements, hardware constraints, and the desired balance between modularity and integration.

For example, demodulator circuit 900 may be preferred when separate control and adjustment of the phase correction and DC removal processes are desirable. It also allows for easier modification or upgrading of the phase correction module without affecting other circuit parts. On the other hand, demodulator circuit 1000 might be chosen when a more compact implementation is desired, or when the phase correction and DC removal functions can be optimized together for better overall performance. The integrated approach could reduce processing delays and simplify the overall signal path.

While not shown in FIGS. 9 and 10 for simplicity, it is understood that additional components such as an ADC, IQ mixer, low-pass filter, slicer, and symbol decoding circuits, as illustrated in FIG. 5, may be included in the demodulator circuit 900 and demodulator circuit 1000 implementations.

As previously discussed, the IQ-to-MP converter circuit 508 is configured to convert demodulated information from Cartesian (In-phase and Quadrature) coordinates to polar (Magnitude and Phase) coordinates. The conversion allows for easier handling of potential phase shift keying (PSK) modulation that may occur in certain wireless power transfer systems.

The phase correction circuit 902 is coupled to the output of the IQ-to-MP converter circuit 508. It is configured to address phase wrap-around issues when the signal constellation approaches the negative real axis in the IQ plane. Phase wrap-around can cause rapid phase changes between −π and +π, potentially leading to symbol detection and decoding errors.

The demodulator circuits 900 and 1000 can provide robust performance across various operating conditions and circuit configurations in wireless power transfer systems by addressing ASK and PSK modulations and phase wrap-around issues.

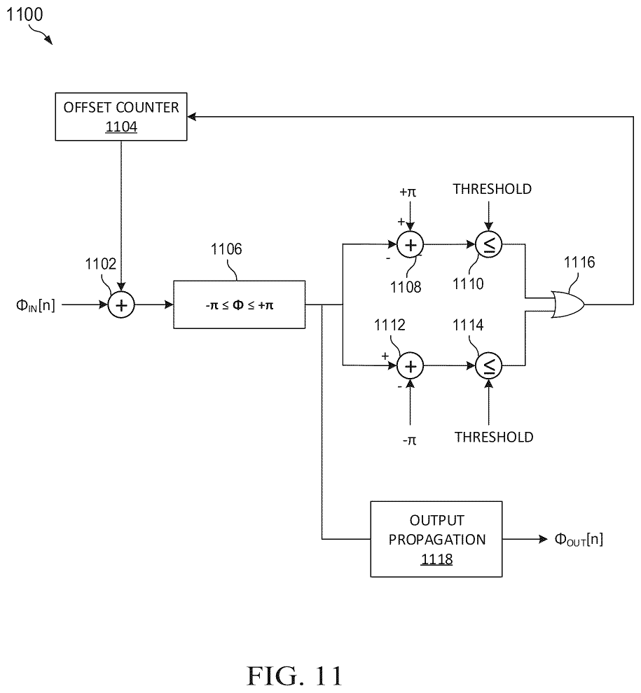

FIG. 11 illustrates a schematic of an embodiment phase correction circuit 1100, which may be implemented as the phase correction circuit 902 of FIG. 9. The phase correction circuit 1100 includes a first adder 1102, an offset counter 1104, a clamping circuit 1106, a second adder 1108, a third adder 1112, a first comparator 1110, a second comparator 1114, an OR gate 1116, and an output propagation circuit 1118, which may (or may not) be arranged as shown. Phase correction circuit 1100 may include additional components not shown.

The phase correction circuit 1100 applies a counter-controlled offset to rotate the signal constellation, addressing phase wrap-around issues. The input phase signal (Φ_{IN}[n]) enters the circuit at the first adder 1102, where it is combined with an offset value from the offset counter 1104. The resulting sum passes through the clamping circuit 1106, which constrains the phase value between −π and +π.

The clamped phase value undergoes two parallel comparisons. In the upper path, the second adder 1108 subtracts the clamped phase from +π (i.e., +π Φ_{IN}[n]), and the first comparator 1110 checks if the result is less than or equal to a first user-configurable threshold. Simultaneously, in the lower path, the third adder 1112 subtracts −π from the clamped phase signal (i.e., Φ_{IN}[n]−(−π)=Φ_{IN}[n]+π), and the second comparator 1114 checks if the result is greater than or equal to a second user-configurable threshold. The comparisons determine if the phase is within a “critical region” near ±π.

The outputs of the first comparator 1110 and the second comparator 1114 feed into the OR gate 1116. If either comparison indicates the phase is in the critical region, the OR gate 1116 triggers the offset counter 1104 to increment by a user-defined value. The increment effectively rotates the IQ axes to move the constellation away from the problematic ±π boundary.

The output propagation circuit 1118 manages the timing of the phase correction process. When the offset counter 1104 is to increment, the output propagation circuit 1118 may delay the output phase signal (Φ_{OUT}[n]) to ensure proper synchronization of the corrected phase value.

The phase correction circuit 1100 continuously monitors the input phase signal (Φ_{IN}[n]) and applies corrections. The offset increment and the threshold values for the comparators can be programmed via firmware, allowing flexibility in adapting the phase correction circuit 1100 to different system requirements. The phase correction circuit 1100 may include optional features such as asserting a maskable interrupt flag when a correction occurs, providing additional system-level control and monitoring capabilities.

By implementing the phase correction strategy, the phase correction circuit 1100 helps mitigate potential decoding errors that could arise from rapid phase changes near the ±π boundary, enhancing the overall reliability of the demodulation process in wireless power transfer systems.

The offset value applied by the offset counter 1104 can be programmed via firmware, allowing flexibility in adapting to different system requirements. For example, a typical offset value might be π/4 radians (45 degrees). This value is often sufficient to move the constellation away from the critical region near the negative x-axis while maintaining a balance between phase correction and signal integrity. The configurable nature of the offset allows system designers to fine-tune the correction based on specific circuit characteristics and operating conditions.

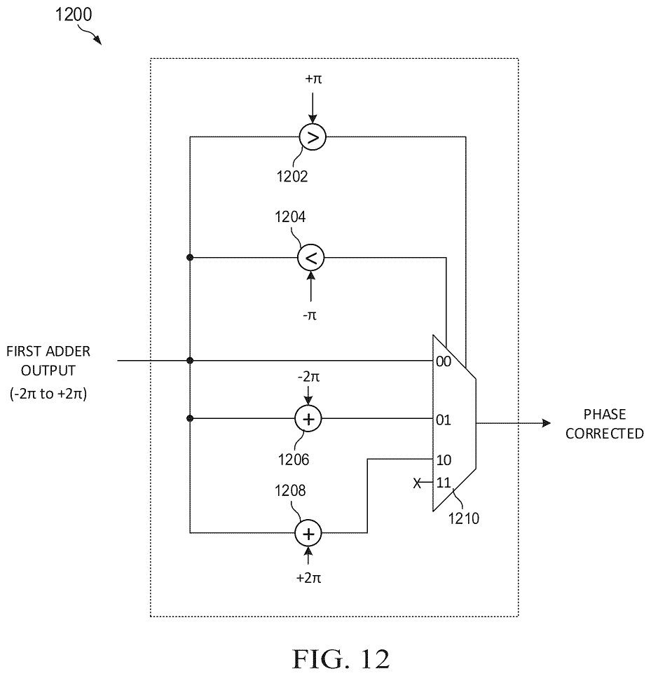

FIG. 12 illustrates a simplified schematic of an embodiment clamping circuit 1200, which may be implemented as the clamping circuit 1106 in FIG. 11. The clamping circuit 1200 includes a first comparator 1202, a second comparator 1204, a first adder 1206, a second adder 1208, and a multiplexer 1210, which may (or may not) be arranged as shown. Clamping circuit 1200 may include additional components that are not shown.

The clamping circuit 1200 bounds the corrected phase within the range of −π to +π. The input to the clamping circuit 1200 is the output of the first adder 1102 from FIG. 11, which can range from −2π to +2π. The first comparator 1202 compares the input to +π, while the second comparator 1204 compares the input to −π. The comparisons determine which operation, if any, needs to be performed to bring the phase value within the desired range.

The outputs of the first comparator 1202 and the second comparator 1204 generate the select signals for the multiplexer 1210. When both comparator outputs are ‘0’, indicating the input is already within the −π to +π range, the multiplexer 1210 passes the input unchanged. If the first comparator 1202 outputs ‘1’ and the second comparator 1204 outputs ‘0’, signifying the input is greater than +π, the multiplexer 1210 selects the output of the first adder 1206. The first adder 1206 subtracts 2π from the input, effectively wrapping the phase back into the desired range. Conversely, if the first comparator 1202 outputs ‘0’ and the second comparator 1204 outputs ‘1’, indicating the input is less than −π, the multiplexer 1210 selects the output of the second adder 1208. The second adder 1208 adds +2π to the input, again wrapping the phase into the −π to +π range.

It is worth noting that the case where both comparators output ‘1’ is not possible, as the input cannot simultaneously be greater than +π and less than −π. This ensures that the phase is always correctly bounded, implementing the frame change necessary for proper phase correction in the demodulation process.

By employing the clamping mechanism, the phase correction circuit 1100 can handle phase values that may exceed the −π to +π range due to the addition of the offset. This ensures that the subsequent processing stages always receive phase values within the expected bounds, contributing to the overall stability and accuracy of the phase correction process in wireless power transfer systems.

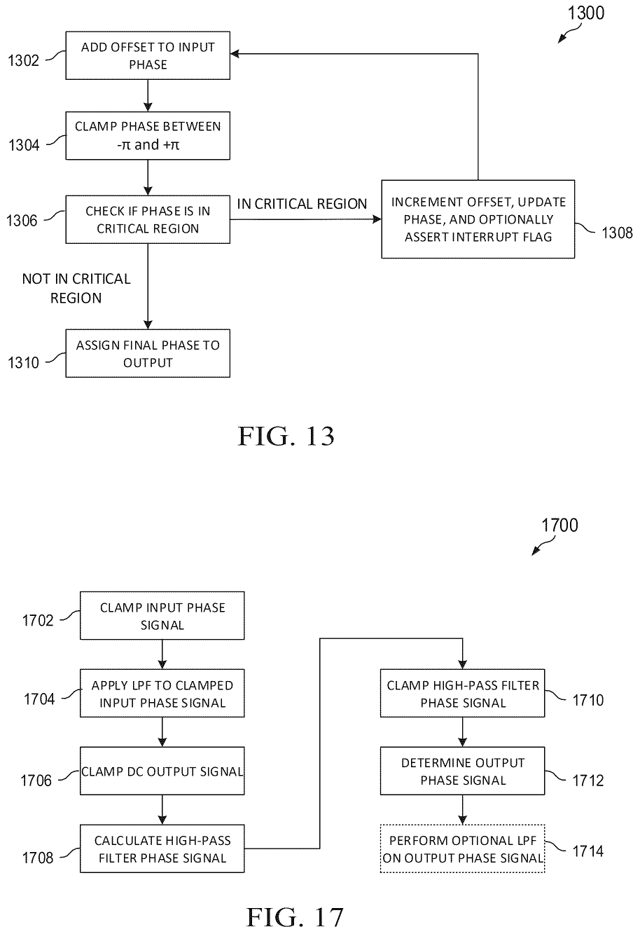

FIG. 13 illustrates a flowchart of an embodiment method 1300, which may be implemented in demodulator circuit 900. It is noted that all steps outlined in the flow chart of method 1300 are not necessarily required and can be optional. Further, changes to the arrangement of the steps, removal of one or more steps and path connections, and addition of steps and path connections are similarly contemplated. Method 1300 describes a process for phase correction to address wrap-around issues.

At step 1302, the offset value from the offset counter 1104 is added to the input phase signal (Φ_{IN}[n]), generating the input phase with a correction offset.

At step 1304, the input phase from step 1302 is clamped between −π and +π using, for example, a clamping circuit to ensure it remains within the valid phase range.

At step 1306, if the clamped phase is checked to determine whether it is within a critical region near the ±π boundaries. This is done by comparing two differences. The first difference includes subtracting the clamped phase from +π. The second difference includes subtracting −π from the clamped phase. If either of these differences is less than or equal to a user-defined threshold, the method proceeds to step 1308. Otherwise, it jumps to step 1310.

At step 1308, the offset value from the offset counter 1104 is incremented by a configurable value and added to the input phase signal (Φ_{IN}[n]), generating an updated input phase with the updated correction offset. At step 1308, an optional maskable interrupt flag may be asserted to signal that a correction has occurred.

Steps 1302 through 1308 are repeated until the differences calculated at step 1306 are greater than the user-defined threshold, at which point the method proceeds to step 1310.

At step 1310, the final phase with the correction value is assigned to the output phase signal (Φ_{OUT}[n]).

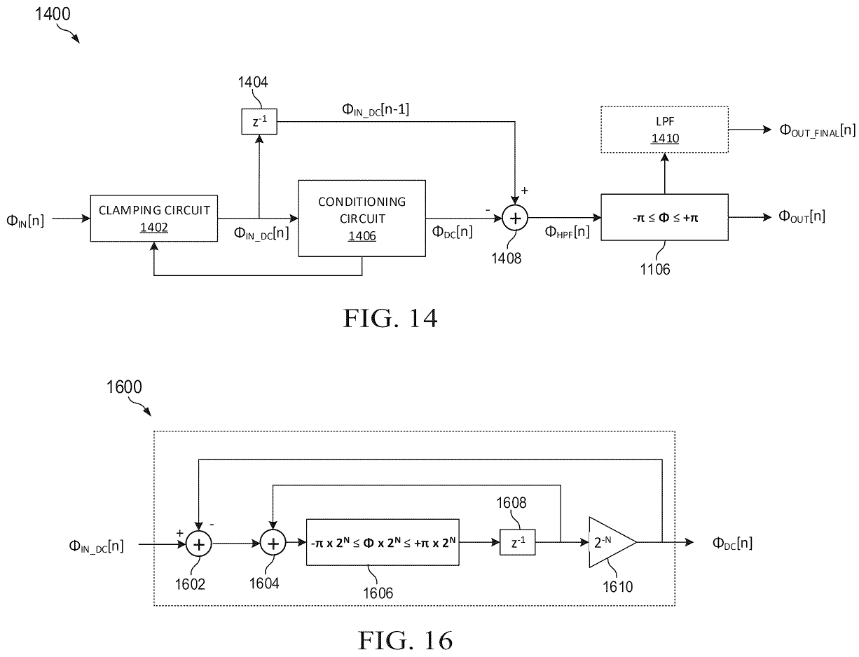

FIG. 14 illustrates a schematic of an embodiment phase correction circuit 1400, which may be implemented as DC removal with phase correction circuit 1002 of FIG. 10. The phase correction circuit 1400 employs an exponential moving average filter implemented as a low-pass IIR filter to extract and remove the DC component of the input phase signal, effectively moving the entire constellation towards the positive x-axis.

The phase correction strategy employed by phase correction circuit 1400 moves the entire constellation towards the positive x-axis by constructing a DC value of the phase signal. The process treats −π and +π as the same angle, effectively wrapping the phase around the unit circle and preventing discontinuities at the boundary points. The approach ensures smooth phase transitions and improves the robustness of the demodulation process, particularly in scenarios where the signal constellation approaches the negative real axis in the IQ plane.

The phase correction circuit 1400 includes an input clamping circuit 1402, a delay circuit (z⁻¹) 1404, a conditioning circuit 1406, a subtraction circuit 1408, the clamping circuit 1106, and an optional low-pass filter (LPF) 1410, which may (or may not) be arranged as shown. Phase correction circuit 1400 may include additional components not shown.

The input phase signal (Φ_{IN}[n]) passes through the input clamping circuit 1402 that controls the input to the low-pass filter of the conditioning circuit 1406. The conditioning circuit 1406 implements an exponential moving average filter, extracting the DC signal (Φ_{DC}[n]) from the input phase signal (Φ_{IN}[n]). The extracted DC component is subtracted from the delayed input phase signal (Φ_{IN}[n−1]) by the subtraction circuit 1408. The delay circuit (z⁻¹) 1404 introduces a one-sample delay to align the input phase with the extracted DC component.

The output signal (Φ_{HPF}[n]) of the subtraction circuit 1408 passes through the clamping circuit 1106, which ensures the output phase signal (Φ_{OUT}[n]) remains within the −π to +π range. The clamping operation maintains phase continuity and prevents abrupt jumps in the phase signal.

The optional low-pass filter (LPF) 1410 may be applied to the output for additional smoothing, providing further flexibility in signal processing. The optional low-pass filter (LPF) 1410 can be enabled or disabled based on specific application requirements, producing the final output phase signal (Φ_{OUT_FINAL}[n]).

The multiple clamping stages throughout the phase correction circuit 1400, including the input clamping circuit 1402 and the clamping circuit 1106, prevent overflow and maintain phase values within the desired range. This contributes to the overall stability and reliability of the phase correction process.

Throughout the phase correction process, when clamping operations are performed by the input clamping circuit 1402, conditioning circuit 1406, and clamping circuit 1106, one or more interrupt flags may be asserted. These flags can provide valuable information to the system about the occurrence of phase wraparound events, allowing for potential adjustments or monitoring of the demodulation process in real-time.

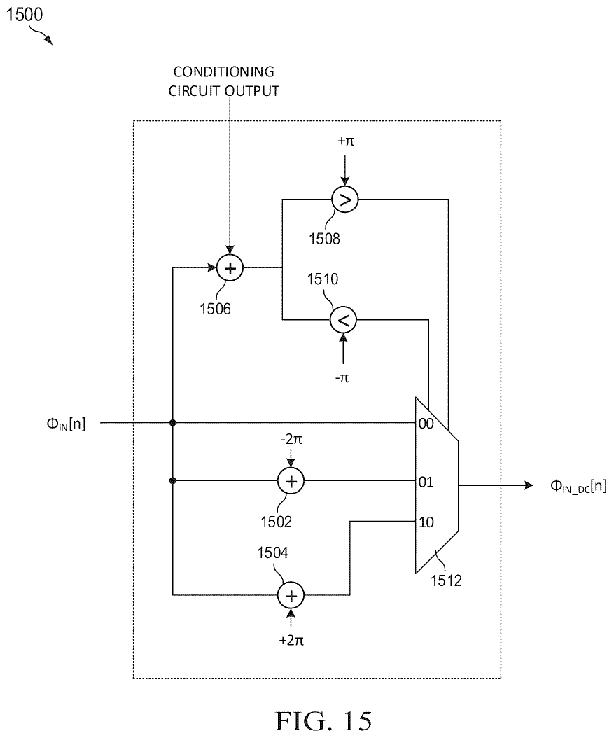

FIG. 15 illustrates a schematic of an embodiment input clamping circuit 1500, which may be implemented as the input clamping circuit 1402 of FIG. 14. Input clamping circuit 1500 includes a first adder 1502, a second adder 1504, a third adder 1506, a first comparator 1508, a second comparator 1510, and a multiplexer 1512, which may (or may not) be arranged as shown. Input clamping circuit 1500 may include additional components not shown.

The input clamping circuit 1500 is configured to clamp the input phase signal (Φ_{IN}[n]) between −π and +π while handling phase wraparound conditions. The input clamping circuit 1500 takes two inputs: the input phase signal (Φ_{IN}[n]) and the output of the conditioning circuit 1406 from FIG. 14.

The third adder 1506 subtracts the conditioning circuit output from the input phase signal (Φ_{IN}[n]). The difference is then compared to +π by the first comparator 1508 and to −π by the second comparator 1510. The comparisons determine if the phase difference exceeds the ±π range, indicating a wraparound condition.

The first adder 1502 subtracts 2π from the input phase, while the second adder 1504 adds 2π to the input phase. The operations prepare the alternative phase values for potential wraparound correction.

The multiplexer 1512 selects the appropriate output based on the comparator results. If the phase difference is greater than +π, the multiplexer 1512 selects the output of the first adder (i.e., Φ_{IN}[n]−2π). If the phase difference is less than −π, the multiplexer 1512 selects the output of the second adder (i.e., Φ_{IN}[n]+2π). Otherwise, multiplexer 1512 passes the original input phase signal (Φ_{IN}[n]) unchanged.

The output of the multiplexer 1512 is the clamped input phase signal (Φ_{IN_DC}[n]), which is guaranteed to be within the −π to +π range. The clamping operation maintains phase continuity and prevents abrupt jumps in the phase signal, which could lead to errors in subsequent processing stages of the demodulation circuit.

FIG. 16 illustrates a schematic of an embodiment conditioning circuit 1600, which may be implemented as the conditioning circuit 1406 of FIG. 14. Conditioning circuit 1600 includes a first adder 1602, a second adder 1604, a clamping circuit 1606, a delay circuit (z⁻¹) 1608, and an attenuator 1610, which may (or may not) be arranged as shown. Conditioning circuit 1600 may include additional components not shown.

The conditioning circuit 1600 functions as an exponential moving average filter implemented as a low-pass IIR filter to extract the DC component from the input phase signal. The input to the conditioning circuit 1600 is the clamped input phase signal (Φ_{IN_DC}[n]) from the input clamping circuit 1402.

The first adder 1602 subtracts a feedback signal from the clamped input phase signal (Φ_{IN_DC}[n]). The first feedback signal is generated at the output of the attenuator 1610. The output of the first adder 1602 passes through the second adder 1604, which incorporates the output of the clamping circuit 1606 from the previous sample provided at the output of the delay circuit (z⁻¹) 1608.

The clamping circuit 1606 is similar to the clamping circuit 1106 but includes an amplification factor of 2^{N}. The factor 2^{N} is chosen to match the attenuation applied later in the filter chain by the attenuator 1610, which applies a factor of 2^{-N} to the signal. The design ensures that the system's overall gain remains unity after the amplification through the clamping circuit 1606. The value of N is configurable, allowing adjustment of the filter's cutoff frequency and its ability to extract the DC component effectively.

The output of the clamping circuit 1606 is fed into the delay circuit (z⁻¹) 1608, which introduces a one-sample delay (z⁻¹). The delayed phase signal is attenuated by the attenuator 1610, which applies a factor of 2^{-N} to the signal.

The attenuator 1610 output is fed back to the first adder 1602, completing the feedback loop of the IIR filter. The feedback mechanism allows for the exponential moving average behavior of the filter.

The DC signal (Φ_{DC}[n]) of the conditioning circuit 1600 can be expressed as φ_{DC}[n]=2^{-N}φ_{¿}[n−1]+(1−2^{-N})φ_{DC}[n−1]. The equation represents the exponential moving average, where N is a configurable parameter that affects the filter's time constant and cutoff frequency—a higher value of N results in a lower cutoff frequency, allowing for more aggressive DC extraction.

The DC signal (Φ_{DC}[n]) of the conditioning circuit 1600 is fed to the subtraction circuit 1408 in FIG. 14 for DC removal from the input phase signal (Φ_{IN}[n])) and back to the input clamping circuit 1402 to assist in handling phase wraparound conditions.

By implementing the conditioning circuit 1600, the overall phase correction system can effectively extract and remove the DC component of the phase signal, helping to mitigate phase wrap-around issues and improve the accuracy of the demodulation process.

FIG. 17 illustrates a flow chart of an embodiment method 1700, which may be implemented in demodulator circuit 1000. It is noted that all steps outlined in the flow chart of method 1700 are not necessarily required and can be optional. Further, changes to the arrangement of the steps, removal of one or more steps and path connections, and addition of steps and path connections are similarly contemplated. Method 1700 describes a process for phase correction to address wrap-around issues.

Step 1702 controls the input to the low-pass filter, ensuring it remains within the desired range. At step 1702, the input phase signal (Φ_{IN}[n]) is clamped between −π and +π. In response to the difference between the input phase signal (Φ_{IN}[n]) and the DC signal (Φ_{DC}[n]) being greater than +π, the clamped input phase signal (Φ_{IN_DC}[n]) is set to Φ_{IN_DC}[n]−2π. In response to the difference between the input phase signal (Φ_{IN}[n]) and the DC signal (Φ_{DC}[n]) being less than +π, the clamped input phase signal (Φ_{IN_DC}[n]) is set to Φ_{IN_DC}[n]+2π. Otherwise, the clamped input phase signal (Φ_{IN_DC}[n]) is set to the input phase signal (Φ_{IN}[n]).

At step 1704, the clamped input phase signal (Φ_{IN_DC}[n]) is sent to a low-pass filter (LPF). The output of the LPF is the DC signal (Φ_{DC}[n]), which represents the average phase value.

At step 1706, the DC signal (Φ_{DC}[n]) is clamped between −π and +π to ensure it remains within the valid phase range.

At step 1708, a high-pass filtered phase signal (Φ_{HPF}[n]) is calculated by subtracting the DC signal (Φ_{DC}[n]) from the clamped input phase signal (Φ_{IN_DC}[n])

At step 1710, The resulting high-pass filtered phase signal (Φ_{HPF}[n]) is clamped between −π and +π to maintain it within the valid phase range.

At step 1712, the output phase signal (Φ_{OUT}[n]) is set equal to the clamped high-pass filtered phase signal (Φ_{HPF}[n]).

Optionally, at step 1714, an additional low-pass filtering operation may be performed on output phase signal (Φ_{OUT}[n]) for further smoothing.

When clamping operations are performed, one or more interrupt flags may be asserted to signal these events to the system.

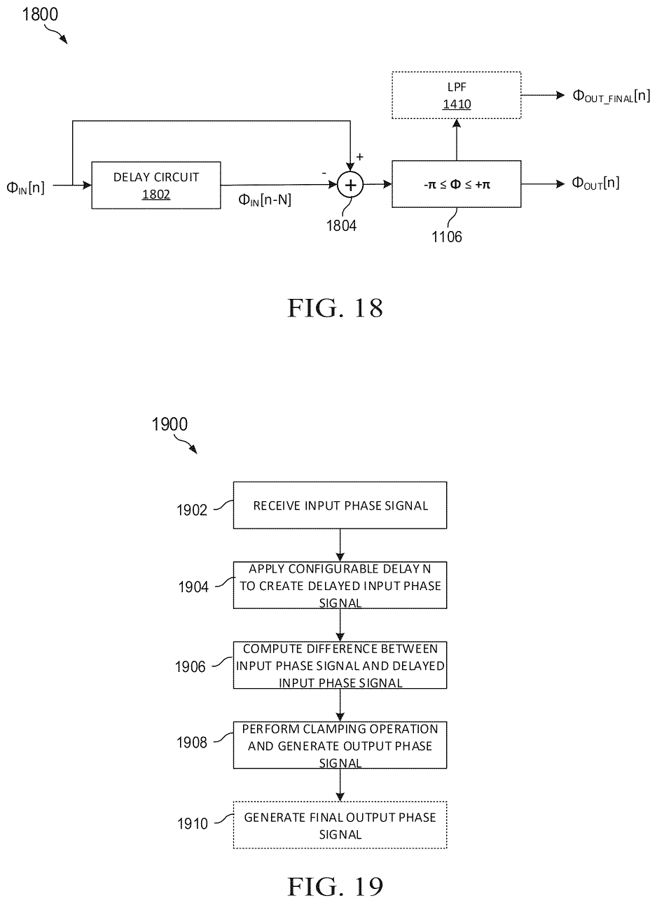

FIG. 18 illustrates a schematic of an embodiment phase correction circuit 1800, which may be implemented as DC removal with phase correction circuit 1002 of FIG. 10. The phase correction circuit 1800 employs a differential comb filter approach to remove the DC component and address phase wrap-around issues.

Phase correction circuit 1800 includes a delay circuit 1802, a subtraction circuit 1804, the clamping circuit 1106, and the optional low-pass filter (LPF) 1410, which may (or may not) be arranged as shown. Phase correction circuit 1800 may include additional components that are not shown. These components work together to implement the differential comb filter strategy for phase correction.

The input phase signal (Φ_{IN}[n]) enters the delay circuit 1802, which introduces a configurable delay of N samples. The delayed phase signal (Φ_{IN}[n−N])) represents the input value occurring N samples before the current input phase. The delay length N can be adjusted based on application requirements.

The configurable delay N in the delay circuit 1802 determines the behavior of the differential comb filter. By adjusting the value of N, which is typically user-definable and programmable via firmware, the filter's characteristics can be fine-tuned for optimal performance. A larger value of N results in a longer delay between the current input phase signal and the sample used for subtraction. The flexibility in configuring N allows the demodulator to adapt to different signal characteristics and system requirements, enhancing its versatility across various wireless power transfer applications.

The subtraction circuit 1804 computes the difference between the current input phase signal (Φ_{IN}[n]) and the delayed phase signal (Φ_{IN}[n−N])). The subtraction effectively implements the differential comb filter, removing the DC component of the phase signal. The resulting signal represents the high-frequency components of the phase, with the DC component removed.

The output of the subtraction circuit 1804 passes through the clamping circuit 1106, which ensures the output phase signal (Φ_{OUT}[n]) remains within the −π to +π range. The clamping operation maintains phase continuity and prevents abrupt jumps in the phase signal.

An optional low-pass filter (LPF) 1410 may be applied to the output phase signal (Φ_{OUT}[n]) for additional smoothing, providing further flexibility in signal processing. The optional low-pass filter (LPF) 1410 can be enabled or disabled based on specific application requirements, producing the final output phase signal (Φ_{OUT_FINAL}[n]).

By implementing this differential comb filter approach, the phase correction circuit 1800 effectively moves the constellation towards the positive x-axis while removing the DC component.

The configurable delay N allows for fine-tuning of the filter's behavior, enabling adaptation to different signal characteristics and system requirements. The flexibility makes the phase correction circuit 1800 suitable for a wide range of wireless power transfer applications where accurate phase demodulation is critical.

FIG. 19 illustrates a flow chart of an embodiment method 1900, which may be implemented in demodulator circuit 1000. Method 1900 describes a process for phase correction to address wrap-around issues using a differential comb filter approach. This method 1900 provides a flexible approach to phase correction, allowing for fine-tuning through the configurable delay N and optional low-pass filtering.

It is noted that all steps outlined in the flow chart of method 1900 are not necessarily required and can be optional. Further, changes to the arrangement of the steps, removal of one or more steps and path connections, and addition of steps and path connections are similarly contemplated.

At step 1902, the input phase signal (Φ_{IN}[n]) is received by the phase correction circuit 1800.

At step 1904, a configurable delay of N samples is introduced to the input phase signal. This creates a delayed version of the input signal (i.e., Φ_{IN}[n−N])), N being a user-definable parameter that can be adjusted based on specific application requirements.

At step 1906, the difference between the current input phase signal (Φ_{IN}[n]) and the delayed phase signal (Φ_{IN}[n−N])) is computed. The subtraction operation effectively implements the differential comb filter, removing the DC component of the phase signal.

At step 1908, the result of the subtraction is clamped between −π and +π. The clamping operation ensures that the output phase signal (Φ_{OUT}[n]) remains within the valid phase range, maintaining phase continuity and preventing abrupt jumps in the phase signal. The output phase signal (Φ_{OUT}[n]) represents the phase-corrected signal with the DC component removed, and the constellation effectively moved towards the positive x-axis.

Optionally, at step 1910, the output phase signal (Φ_{OUT}[n]) is passed through a low-pass filter for additional smoothing and a final output phase signal (Φ_{OUT_FINAL}[n]) is produced. This step can be enabled or disabled based on specific application requirements.

Throughout the process, when clamping operations are performed, one or more interrupt flags may be asserted to signal these events to the system.

Accordingly, the phase correction techniques described offer different approaches to addressing phase wrap-around issues. These techniques can be broadly categorized into offset application and DC removal.

The phase correction circuit 1100 employs an offset application strategy. This approach shifts the position of the two symbols in the IQ plane to a region that is not close to the negative x-axis. By applying a carefully calculated offset, the circuit ensures that the phase information remains in a more stable region of the IQ plane, reducing the likelihood of wrap-around errors during demodulation.

In contrast, the phase correction circuit 1400 and the phase correction circuit 1800 utilize a DC removal strategy. These circuits eliminate the DC component of the phase signal. This DC removal moves the entire constellation to a symmetric region to the positive x-axis in the IQ plane. The symmetry helps to distribute the phase information more evenly around the origin, minimizing the impact of phase discontinuities at the ±π boundaries.

While these approaches may differ in their specific implementations, they aim to improve phase demodulation's reliability and accuracy. By mitigating phase wrap-around issues, these circuits contribute to more robust communication between power receivers and transmitters, enhancing the overall performance of wireless power transfer technologies.

Further, the various approaches (e.g., offset application, DC removal with an exponential moving average filter, and a differential comb filter approach) can be implemented individually or in combination, depending on the system's requirements. Each approach offers advantages in addressing phase wrap-around issues and improving demodulation accuracy. The flexibility to choose between each individually or in combination allows for optimized performance across various operating conditions and circuit configurations.

A first aspect relates to a system for wireless power transfer. The system comprising a receiving device configured to receive wireless power; and a transmitting device configured to transmit the wireless power to the receiving device, wherein the transmitting device comprises a demodulator circuit configured to receive a phase shift keying (PSK) modulated signal from the receiving device, convert the PSK modulated signal from Cartesian coordinates to polar coordinates, and perform phase correction on the converted signal to mitigate rapid phase fluctuations that occur when a signal constellation approaches a negative real axis in an in-phase and quadrature (IQ) plane.

In a first implementation form of the system, according to the first aspect as such, the demodulator circuit is further configured to perform phase correction by applying a counter-controlled offset to rotate the signal constellation away from the negative real axis in the IQ plane.

In a second implementation form of the system, according to the first aspect as such or any preceding implementation form of the first aspect, the demodulator circuit comprises an adder configured to add an offset value to an input phase signal; a clamping circuit configured to clamp an output of the adder between −π and +π; a comparator configured to determine if the clamped phase is within a critical region near the negative real axis, wherein the critical region is a range of phase angles within a predetermined threshold of ±π radians in the IQ plane; and an offset counter configured to increment the offset value when the clamped phase is within the critical region.

In a third implementation form of the system, according to the first aspect as such or any preceding implementation form of the first aspect, the demodulator circuit is further configured to perform phase correction by removing a DC component from the converted signal using an exponential moving average filter.

In a fourth implementation form of the system, according to the first aspect as such or any preceding implementation form of the first aspect, the demodulator circuit comprises an input clamping circuit; a conditioning circuit configured to implement the exponential moving average filter; a subtraction circuit configured to subtract an output of the conditioning circuit from a delayed input phase signal; and an output clamping circuit.

In a fifth implementation form of the system, according to the first aspect as such or any preceding implementation form of the first aspect, the demodulator circuit is further configured to perform phase correction by removing a DC component from the converted signal using a differential comb filter.

In a sixth implementation form of the system, according to the first aspect as such or any preceding implementation form of the first aspect, the demodulator circuit comprises a delay circuit configured to delay an input phase signal by a configurable number of samples; a subtraction circuit configured to compute a difference between the input phase signal and the delayed input phase signal; and a clamping circuit configured to clamp an output of the subtraction circuit between −π and +π.

A second aspect relates to a method for phase-based demodulation in a wireless power transfer system. The method comprising receiving a phase shift keying (PSK) modulated signal from a receiving device at a transmitting device; converting the PSK modulated signal from Cartesian coordinates to polar coordinates; and performing phase correction on the converted signal to mitigate rapid phase fluctuations occurring when a signal constellation approaches a negative real axis in an in-phase and quadrature (IQ) plane.

In a first implementation form of the method, according to the second aspect as such, performing phase correction comprises applying a counter-controlled offset to rotate the signal constellation away from the negative real axis in the IQ plane.

In a second implementation form of the method, according to the second aspect as such or any preceding implementation form of the second aspect, the method further includes adding an offset value to an input phase signal; clamping a result of the adding between −π and +π; determining if the clamped phase is within a critical region near the negative real axis, wherein the critical region is a range of phase angles within a predetermined angular threshold in the IQ plane; and incrementing the offset value when the clamped phase is within the critical region.

In a third implementation form of the method, according to the second aspect as such or any preceding implementation form of the second aspect, performing phase correction comprises removing a DC component from the converted signal using an exponential moving average filter.

In a fourth implementation form of the method, according to the second aspect as such or any preceding implementation form of the second aspect, the method further includes clamping an input phase signal; applying the exponential moving average filter to the clamped input phase signal; subtracting an output of the exponential moving average filter from a delayed input phase signal; and clamping a result of the subtracting between −π and +π.

In a fifth implementation form of the method, according to the second aspect as such or any preceding implementation form of the second aspect, performing phase correction comprises removing a DC component from the converted signal using a differential comb filter.

In a sixth implementation form of the method, according to the second aspect as such or any preceding implementation form of the second aspect, the method further includes delaying an input phase signal by a configurable number of samples; computing a difference between the input phase signal and the delayed input phase signal; and clamping the computed difference between −π and +π.

A third aspect relates to a demodulator circuit for a wireless power transfer system. The demodulator circuit comprising an in-phase and quadrature (IQ) mixer configured to downconvert a received phase shift keying (PSK) modulated signal; a pair of low-pass filters coupled to outputs of the IQ mixer; an in-phase and quadrature to magnitude and phase (IQ-to-MP) converter circuit coupled to outputs of the low-pass filters; and a phase correction circuit coupled to an output of the IQ-to-MP converter circuit, the phase correction circuit configured to mitigate rapid phase fluctuations occurring when a signal constellation approaches a negative real axis in an IQ plane.

In a first implementation form of the demodulator circuit, according to the third aspect as such, the phase correction circuit is configured to apply a counter-controlled offset to rotate the signal constellation away from the negative real axis in the IQ plane.

In a second implementation form of the demodulator circuit, according to the third aspect as such or any preceding implementation form of the third aspect, the phase correction circuit comprises an adder configured to add an offset value to an input phase signal; a clamping circuit configured to clamp an output of the adder between −π and +π; a comparator configured to determine if the clamped phase is within a critical region near the negative real axis, wherein the critical region is a range of phase angles within a predetermined angular threshold in the IQ plane; and an offset counter configured to increment the offset value when the clamped phase is within the critical region.

In a third implementation form of the demodulator circuit, according to the third aspect as such or any preceding implementation form of the third aspect, the phase correction circuit is configured to remove a DC component from the converted signal using an exponential moving average filter.

In a fourth implementation form of the demodulator circuit, according to the third aspect as such or any preceding implementation form of the third aspect, the phase correction circuit comprises an input clamping circuit; a conditioning circuit configured to implement the exponential moving average filter; a subtraction circuit configured to subtract an output of the conditioning circuit from a delayed input phase signal; and an output clamping circuit.

In a fifth implementation form of the demodulator circuit, according to the third aspect as such or any preceding implementation form of the third aspect, the phase correction circuit is configured to remove a DC component from the converted signal using a differential comb filter. The phase correction circuit comprising a delay circuit configured to delay an input phase signal by a configurable number of samples; a subtraction circuit configured to compute a difference between the input phase signal and the delayed input phase signal; and a clamping circuit configured to clamp an output of the subtraction circuit between −π and +π.

Although the description has been described in detail, it should be understood that various changes, substitutions, and alterations may be made without departing from the spirit and scope of this disclosure as defined by the appended claims. The same elements are designated with the same reference numbers in the various figures. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, may perform substantially the same function or achieve substantially the same result as the corresponding embodiments described herein. Accordingly, the appended claims are intended to include within their scope such processes, machines, manufacture, compositions of matter, means, methods, or steps.

The specification and drawings are, accordingly, to be regarded simply as an illustration of the disclosure as defined by the appended claims, and are contemplated to cover any and all modifications, variations, combinations, or equivalents that fall within the scope of the present disclosure.

What is claimed is:

1. A system for wireless power transfer, the system comprising:
a receiving device configured to receive wireless power; and
a transmitting device configured to transmit the wireless power to the receiving device, wherein the transmitting device comprises a demodulator circuit configured to:
receive a phase shift keying (PSK) modulated signal from the receiving device,
convert the PSK modulated signal from Cartesian coordinates to polar coordinates, and
perform phase correction on the converted signal to mitigate rapid phase fluctuations that occur when a signal constellation approaches a negative real axis in an in-phase and quadrature (IQ) plane.

2. The system of claim 1, wherein the demodulator circuit is further configured to perform phase correction by applying a counter-controlled offset to rotate the signal constellation away from the negative real axis in the IQ plane.

3. The system of claim 2, wherein the demodulator circuit comprises:
an adder configured to add an offset value to an input phase signal;
a clamping circuit configured to clamp an output of the adder between −π and +π;
a comparator configured to determine if the clamped phase is within a critical region near the negative real axis, wherein the critical region is a range of phase angles within a predetermined threshold of ±π radians in the IQ plane; and
an offset counter configured to increment the offset value when the clamped phase is within the critical region.

4. The system of claim 1, wherein the demodulator circuit is further configured to perform phase correction by removing a DC component from the converted signal using an exponential moving average filter.

5. The system of claim 4, wherein the demodulator circuit comprises:
an input clamping circuit;
a conditioning circuit configured to implement the exponential moving average filter;
a subtraction circuit configured to subtract an output of the conditioning circuit from a delayed input phase signal; and
an output clamping circuit.

6. The system of claim 1, wherein the demodulator circuit is further configured to perform phase correction by removing a DC component from the converted signal using a differential comb filter.

7. The system of claim 6, wherein the demodulator circuit comprises:
a delay circuit configured to delay an input phase signal by a configurable number of samples;
a subtraction circuit configured to compute a difference between the input phase signal and the delayed input phase signal; and
a clamping circuit configured to clamp an output of the subtraction circuit between −π and +π.

8. A method for phase-based demodulation in a wireless power transfer system, the method comprising:
receiving a phase shift keying (PSK) modulated signal from a receiving device at a transmitting device;
converting the PSK modulated signal from Cartesian coordinates to polar coordinates; and
performing phase correction on the converted signal to mitigate rapid phase fluctuations occurring when a signal constellation approaches a negative real axis in an in-phase and quadrature (IQ) plane.

9. The method of claim 8, wherein performing phase correction comprises applying a counter-controlled offset to rotate the signal constellation away from the negative real axis in the IQ plane.

10. The method of claim 9, further comprising:
adding an offset value to an input phase signal;
clamping a result of the adding between −π and +π;
determining if the clamped phase is within a critical region near the negative real axis, wherein the critical region is a range of phase angles within a predetermined angular threshold in the IQ plane; and
incrementing the offset value when the clamped phase is within the critical region.

11. The method of claim 8, wherein performing phase correction comprises removing a DC component from the converted signal using an exponential moving average filter.

12. The method of claim 11, further comprising:
clamping an input phase signal;
applying the exponential moving average filter to the clamped input phase signal;
subtracting an output of the exponential moving average filter from a delayed input phase signal; and
clamping a result of the subtracting between −π and +π.

13. The method of claim 8, wherein performing phase correction comprises removing a DC component from the converted signal using a differential comb filter.

14. The method of claim 13, further comprising:
delaying an input phase signal by a configurable number of samples;
computing a difference between the input phase signal and the delayed input phase signal; and
clamping the computed difference between −π and +π.

15. A demodulator circuit for a wireless power transfer system, the demodulator circuit comprising:
an in-phase and quadrature (IQ) mixer configured to downconvert a received phase shift keying (PSK) modulated signal;
a pair of low-pass filters coupled to outputs of the IQ mixer;
an in-phase and quadrature to magnitude and phase (IQ-to-MP) converter circuit coupled to outputs of the low-pass filters; and
a phase correction circuit coupled to an output of the IQ-to-MP converter circuit, the phase correction circuit configured to mitigate rapid phase fluctuations occurring when a signal constellation approaches a negative real axis in an IQ plane.

16. The demodulator circuit of claim 15, wherein the phase correction circuit is configured to apply a counter-controlled offset to rotate the signal constellation away from the negative real axis in the IQ plane.

17. The demodulator circuit of claim 16, wherein the phase correction circuit comprises:
an adder configured to add an offset value to an input phase signal;
a clamping circuit configured to clamp an output of the adder between −π and +π;
a comparator configured to determine if the clamped phase is within a critical region near the negative real axis, wherein the critical region is a range of phase angles within a predetermined angular threshold in the IQ plane; and
an offset counter configured to increment the offset value when the clamped phase is within the critical region.

18. The demodulator circuit of claim 15, wherein the phase correction circuit is configured to remove a DC component from the converted signal using an exponential moving average filter.

19. The demodulator circuit of claim 18, wherein the phase correction circuit comprises:
an input clamping circuit;
a conditioning circuit configured to implement the exponential moving average filter;
a subtraction circuit configured to subtract an output of the conditioning circuit from a delayed input phase signal; and
an output clamping circuit.

20. The demodulator circuit of claim 15, wherein the phase correction circuit is configured to remove a DC component from the converted signal using a differential comb filter, the phase correction circuit comprising:
a delay circuit configured to delay an input phase signal by a configurable number of samples;
a subtraction circuit configured to compute a difference between the input phase signal and the delayed input phase signal; and
a clamping circuit configured to clamp an output of the subtraction circuit between −π and +π.
